(19) United States
(12) Patent Application Publication
(10) Pub. No.: US 2026/0369653 A1
(43) Pub. Date: Nov. 19, 2026

(54) CYLINDRICAL BATTERY

(71) Applicant: Panasonic Energy Co., Ltd., Osaka (JP)

(72) Inventor: Sho SAITO, Osaka (JP)

(21) Appl. No.: 19/133,607

(22) PCT Filed: Dec. 25, 2023
(86) PCT No.: PCT/JP2023/046338

§ 371 Date: May 28, 2025

(30) Foreign Application Priority Data
Dec. 26, 2022 (JP) 2022-207820

(51) Int. Cl. H01M 10/04; H01M 50/107; H01M 50/184; H01M 50/559

(52) U.S. Cl. CPC H01M 10/0422; H01M 50/107; H01M 50/184; H01M 50/559

(57) ABSTRACT

A cylindrical battery as an example of an embodiment comprises: a bottomed cylindrical exterior can; a sealing body closing an opening portion of the exterior can; a gasket disposed between the exterior can and the sealing body; an outer terminal bonded to an outer surface of the exterior can; and an insulating member interposed between the sealing body and the outer terminal. The insulating member has a first projection and a second projection which protrudes on the outer terminal side and hangs over an outer surface of the outer terminal. The sealing body has a groove in which the first projection is inserted, and is fixed to the outer terminal with the insulating member therebetween.

### TECHNICAL FIELD

The present disclosure relates to a cylindrical battery.

### BACKGROUND ART

Cylindrical batteries generally comprise a winding type electrode assembly, a bottomed cylindrical outer can that houses the electrode assembly, and a sealing assembly that seals an opening portion of the outer can. The cylindrical batteries are shock-resistant and easy to modularize. For applications requiring high capacity, a plurality of cylindrical batteries are electrically connected and modularized. In this case, an external terminal of each of the cylindrical batteries is joined to a current collector member that connects the plurality of cylindrical batteries to each other.

Patent Literature 1 discloses a battery module comprising a plurality of cylindrical batteries, the module being configured such that a positive electrode external terminal and a negative electrode external terminal are arranged in one axial end portion of the cylindrical batteries and a connection mediating member is arranged on a circumferential edge portion of the end portion. In the cylindrical batteries in Patent Literature 1, a sealing assembly serves as the positive electrode external terminal, and the outer can serves as the negative electrode external terminal. The connection mediating member, which is a ring-shaped member with a hole in the center, is electrically connected to the outer can. Here, Patent Literature 1 describes the effect that using the connection mediating member increases a joint area of the current collector member on the negative electrode side so that strong connection can be achieved with low resistance.

### CITATION LIST

### Patent Literature

Patent Literature 1: International Publication No. WO 2019/244392

### SUMMARY

As in the cylindrical batteries in Patent Literature 1, when the sealing assembly serves as an external terminal of a first electrode and the outer can serves as an external terminal of a second electrode, it is necessary to prevent a short circuit caused by contact between the sealing assembly and the outer can. While the cylindrical battery has a gasket arranged to seal a gap between the sealing assembly and the outer can, the gasket also functions as an insulating member to prevent an electrical contact between the sealing assembly and the outer can. However, the gasket may melt when the temperature of the battery rises on the occurrence of abnormality in the battery. When the gasket melts, there is a concern that the sealing assembly may drop into the inside of the battery and come into contact with the outer can, causing a short circuit.

A cylindrical battery according to the present disclosure comprises: an electrode assembly including a first electrode and a second electrode; a bottomed cylindrical outer can that houses the electrode assembly; and a sealing assembly that seals an opening portion of the outer can, the first electrode being connected to the outer can, the second electrode being connected to the sealing assembly, the cylindrical battery further comprising: a gasket interposed between the outer can and the sealing assembly; an external terminal joined to an outer surface of the outer can; and an insulating member interposed between the sealing assembly and the external terminal, in which the sealing assembly is fixed to the external terminal via the insulating member.

In the cylindrical battery according to the present disclosure, the sealing assembly is fixed to the external terminal via the insulating member. Therefore, even when the gasket melts due to abnormal heat generated in the battery, the occurrence of a short circuit due to contact between the outer can and the sealing assembly is suppressed. In other words, the sealing assembly is held by the external terminal to prevent the sealing assembly from dropping.

### BRIEF DESCRIPTION OF DRAWING

FIG. 1 is a sectional view of a cylindrical battery as one example of an embodiment.

FIG. 2 is an enlarged view of a portion A in FIG. 1.

FIG. 3 is a perspective view of an insulating member as one example of the embodiment.

### DESCRIPTION OF EMBODIMENTS

Hereinafter, one example of an embodiment of a cylindrical battery according to the present disclosure will be described in detail with reference to the drawings. Here, the cylindrical battery according to the present disclosure is not limited to the embodiment described below.

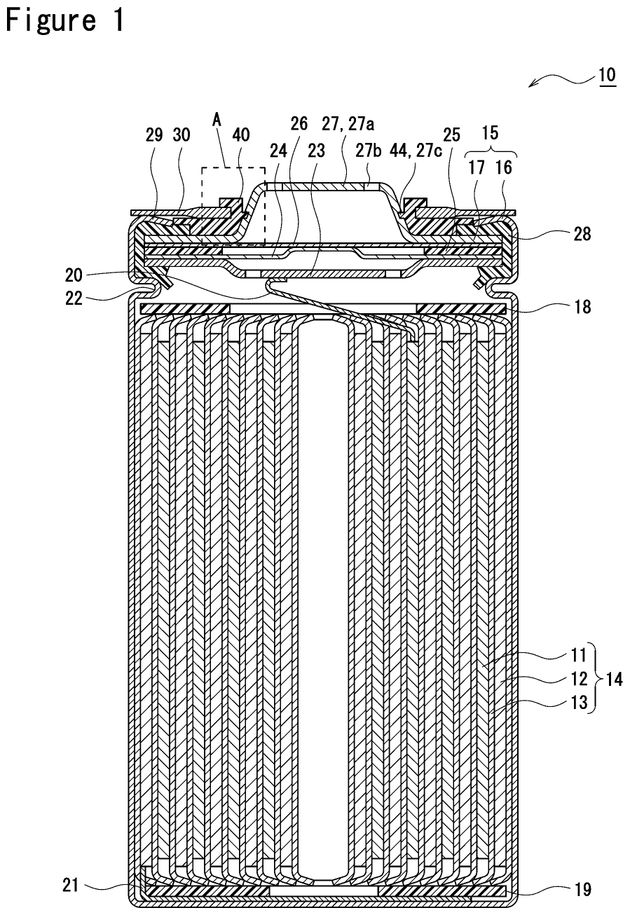

FIG. 1 is a sectional view of a cylindrical battery 10 as one example of the embodiment, the sectional view showing the cross section of the cylindrical battery 10 taken along an axial direction of the battery.

As shown in FIG. 1, the cylindrical battery 10 comprises an electrode assembly 14, a bottomed cylindrical outer can 16 that houses the electrode assembly 14, and a sealing assembly 17 that seals an opening portion of the outer can 16. The outer can 16 houses an electrolyte together with the electrode assembly 14. The outer can 16 includes a grooved portion 22 formed on its side wall, and the sealing assembly 17 is supported by the grooved portion 22 to seal the opening portion of the outer can 16. The outer can 16 and the sealing assembly 17 constitute a case 15 having a substantially columnar shape as a whole. Hereinafter, for the convenience of description, the side of the cylindrical battery 10 closer to the sealing assembly 17 is defined as an upper side, and a can-bottom side of the outer can 16 is defined as a lower side.

As described in detail later, the cylindrical battery 10 has a structure in which a first electrode constituting the electrode assembly 14 is connected to the outer can 16, and a second electrode constituting the electrode assembly 14 is connected to the sealing assembly 17. In the present embodiment, the first electrode is a positive electrode 11 and the second electrode is a negative electrode 12.

The cylindrical battery 10 further comprises a gasket 28 interposed between the outer can 16 and the sealing assembly 17. The gasket 28, which is a ring-shaped resin member that is attached to an outer circumferential portion of the sealing assembly 17, closes the gap between the outer can 16 and the sealing assembly 17 to seal the inside of the battery. The gasket 28 also prevents contact between the outer can 16 and the sealing assembly 17 to ensure insulation between the outer can 16 and the sealing assembly 17. The gasket 28 may be made of any material, and may be made of polyolefin in one example.

The cylindrical battery 10 further comprises an external terminal 30 joined to the outer surface of the outer can 16 and an insulating member 40 interposed between the sealing assembly 17 and the external terminal 30. The external terminal 30 is a conductive member connected to a current collector member, which electrically connects the plurality of cylindrical batteries 10 to each other when the cylindrical batteries 10 are modularized, for example. In the present embodiment, the external terminal 30 is arranged on the upper surface of the case 15 and is welded to a caulked portion 29 of the outer can 16 that is formed at the circumferential edge of the upper surface. The insulating member 40 ensures insulation between the sealing assembly 17 and the external terminal 30, and also functions as fixing means to fix the sealing assembly 17 to the external terminal 30.

The electrolyte may be an aqueous electrolyte, though in the present embodiment, a non-aqueous electrolyte is used. The non-aqueous electrolyte has lithium ion conductivity. The non-aqueous electrolyte may be a liquid electrolyte (electrolyte solution) or a solid electrolyte.

The liquid electrolyte (electrolyte solution) contains non-aqueous solvent and electrolyte salt solved in the non-aqueous solvent. As the non-aqueous solvent, there may be used, for example, esters, ethers, nitriles, amides, and mixed solvent of two or more of the group consisting of esters, ethers, nitriles, and amides. Examples of the non-aqueous solvent may include ethylene carbonate (EC), ethyl methyl carbonate (EMC), dimethyl carbonate (DMC), diethyl carbonate (DEC), and mixed solvent thereof. The non-aqueous solvent may contain halogen substitutions (e.g., fluoroethylene carbonate) that replace at least a part of hydrogen in these solvents with halogen atoms such as fluorine. As the electrolyte salt, lithium salt such as LiPF₆ is used.

As the solid electrolyte, there may be used, for example, solid or gel-like polymer electrolyte, inorganic solid electrolyte, or the like. As the inorganic solid electrolyte, materials that are publicly known in all solid lithium-ion secondary batteries (e.g., oxide-based solid electrolyte, sulfide-based solid electrolyte, halogen-based solid electrolyte, etc.) may be used. The polymer electrolyte contains, for example, lithium salt and matrix polymer, or non-aqueous solvent, lithium salt, and matrix polymer. As the matrix polymer, a polymer material that is made to gel by absorbing non-aqueous solvent is used, for example. Examples of the polymer material may include fluororesin, acrylic resin, and polyether resin.

The electrode assembly 14, which includes a positive electrode 11, a negative electrode 12, and separators 13, has a winding structure having the positive electrode 11 and the negative electrode 12 wound into a spiral shape through the separators 13. The positive electrode 11, the negative electrode 12, and the separators 13, which are all band-shaped long members, are wound in a spiral shape so as to be stacked alternately in a radial direction of the electrode assembly 14. In order to prevent lithium deposition, the negative electrode 12 is formed with a dimension that is larger than the positive electrode 11. Specifically, the negative electrode 12 is formed to be longer in a longitudinal direction and a width direction than the positive electrode 11. The two separators 13 are also formed with a dimension that is at least larger than the positive electrode 11 and are arranged to hold the positive electrode 11 therebetween, for example.

The electrode assembly 14 includes a positive electrode lead 20 connected to the positive electrode 11 and a negative electrode lead 21 connected to the negative electrode 12. In the present embodiment, the positive electrode lead 20 is connected to the sealing assembly 17, and the negative electrode lead 21 is connected to the outer can 16. Accordingly, the sealing assembly 17 functions as a positive electrode external terminal, and the external terminal 30 joined to the outer can 16 functions as a negative electrode external terminal. In the example shown in FIG. 1, the positive electrode lead 20 extends toward the sealing assembly 17 through an opening portion of an insulating plate 18, and the negative electrode lead 21 extends toward a can-bottom side of the outer can 16 along the outside of an insulating plate 19. Here, the positive electrode lead 20 and the negative electrode lead 21 may each be provided in plurality.

The positive electrode 11 includes a positive electrode core and a positive electrode mixture layer that is formed on at least one face of the core. As the positive electrode core, there may be used a foil made of metal that is stable in a potential range of the positive electrode 11, such as aluminum and aluminum alloy, a film with the metal arranged on its surface layer, or the like. The positive electrode mixture layer preferably contains a positive electrode active material, a conductive agent such as acetylene black, and a binding agent such as polyfluoride vinylidene (PVdF), and formed on both the faces of the positive electrode core. As the positive electrode active material, there is used lithium-transition metal composite oxide containing Ni, Co, Mn, Al, or the like, for example. Note that the positive electrode lead 20 is preferably joined to the positive electrode core directly by ultrasonic welding, or the like.

The negative electrode 12 includes a negative electrode core and a negative electrode mixture layer that is formed on at least one face of the core. As the negative electrode core, there may be used a foil made of metal that is stable in a potential range of the negative electrode 12, such as coper and copper alloy, a film with the metal arranged on its surface layer, or the like. The negative electrode mixture layer preferably contains a negative electrode active material and a binding agent such as styrene-butadiene rubber (SBR), and is formed on both the faces of the negative electrode core. As the negative electrode active material, graphite, Si-containing materials, or the like, is used, for example. The negative electrode lead 21 is preferably joined to the negative electrode core directly by ultrasonic welding, or the like. It is also possible to bring the negative electrode core into contact with the inner surface of the outer can 16 to provide electrical connection between the negative electrode 12 and the outer can 16.

The outer can 16, which is a bottomed cylindrical iron container with one axial end (upper end) being open, includes a side wall formed in a cylindrical shape and a can-bottom having a circular shape as viewed from the bottom. The outer can 16, which is generally constituted of metal mainly composed of iron, may be constituted of metal mainly composed of aluminum, or the like. On the side wall of the outer can 16, the grooved portion 22 is annularly formed over the entire circumferential length. The grooved portion 22 is a part of the side wall that protrudes to the inside of the outer can 16, and is formed by, for example, spinning the side wall from the outside. The grooved portion 22 is formed at a position that is prescribed length away from the upper end of the outer can 16. The prescribed length is, for example, a length corresponding to 1% to 20% of the axial length of the outer can 16.

The sealing assembly 17 is held between the grooved portion 22 and the caulked portion 29 so as to be fixed to an opening edge portion of the outer can 16. In the present embodiment, the caulked portion 29 is formed at the upper end portion of the outer can 16. The caulked portion 29 is a part that is formed by folding the upper end portion of the outer can 16 to the inside of the outer can 16 and caulked to the sealing assembly 17 arranged on the grooved portion 22. The caulked portion 29 is annularly formed along the circumference direction of the outer can 16. The caulked portion 29 is inclined, for example, in the radial direction of the outer can 16 so that the distance from the upper surface of the sealing assembly 17 is shorter toward a radially inside from a radially outside of the outer can 16. The gasket 28 is strongly compressed by the caulked portion 29, and a part of the gasket 28 extends from between the caulked portion 29 and the sealing assembly 17 toward the central axis of the cylindrical battery 10.

As described later in detail, the sealing assembly 17 is fixed to the external terminal 30 via the insulating member 40. Accordingly, even when the gasket 28 melts due to abnormal heat generation in the battery, the occurrence of a short circuit caused by the contact between the outer can 16 and the sealing assembly 17 is suppressed. The sealing assembly 17 and the insulating member 40 have a fixing structure (locking structure) to maintain the state of being coupled to each other. In the present embodiment, the fixing structure comprises a protrusion 44 formed in the insulating member 40 and a groove 27c that is a recessed portion formed in the sealing assembly 17.

The sealing assembly 17 has a structure formed by stacking an internal terminal plate 23, a lower vent member 24, an insulating plate 25, an upper vent member 26, and a cap 27 in this order from the side of the electrode assembly 14. Each member constituting the sealing assembly 17 has, for example, a disc shape or a ring shape, and each member except the insulating plate 25 is electrically connected to each other. The cap 27 is a top plate including a projecting portion 27a with its radial central portion expanding outward. The projecting portion 27a of the cap 27 includes a side surface formed into an annular shape and a flat top surface. The top surface of the projecting portion 27a is located at the upper end of the cylindrical battery 10. Here, a plurality of vent holes 27b are formed on the top surface.

The lower vent member 24, the insulating plate 25, and the upper vent member 26 constitute a current cutoff mechanism. The lower vent member 24 and the upper vent member 26 are connected at their central portions with the insulating plate 25 being interposed between their respective circumferential edge portions. In this case, when abnormality occurs in the battery and the internal pressure rises, the lower vent member 24 deforms so as to push the upper vent member 26 toward the cap 27 and breaks, and as a result, a current path between the lower vent member 24 and the upper vent member 26 is cut off. As the internal pressure further rises, the upper vent member 26 breaks, so that gas is exhausted through the vent holes 27b of the cap 27.

In the present embodiment, the positive electrode lead 20 is connected to the lower surface of the internal terminal plate 23 by welding, ultrasonic welding, or the like, so that the cap 27, which is the top plate of the sealing assembly 17 electrically connected with the internal terminal plate 23, serves as a positive electrode external terminal. The current collector on the positive electrode side that constitutes a battery module is, for example, welded to the top plate of the projecting portion 27a of the cap 27. The negative electrode lead 21 is also connected to the inner surface of the can-bottom of the outer can 16 by welding, ultrasonic welding, or the like, so that the external terminal 30 electrically connected to the outer can 16 serves as a negative electrode terminal. The current collector member on the negative electrode side that constitutes the battery module is welded to the upper surface of the external terminal 30, for example.

In the cylindrical battery 10, both the cap 27 of the sealing assembly 17 that is the positive electrode external terminal and the external terminal 30 that is the negative electrode external terminal are arranged on the upper surface of the battery. Accordingly, when the cylindrical batteries 10 are modularized, the current collector member can be connected to the positive electrode external terminal and the negative electrode external terminal that are arranged in close proximity, which makes it possible to miniaturize the module and improve productivity.

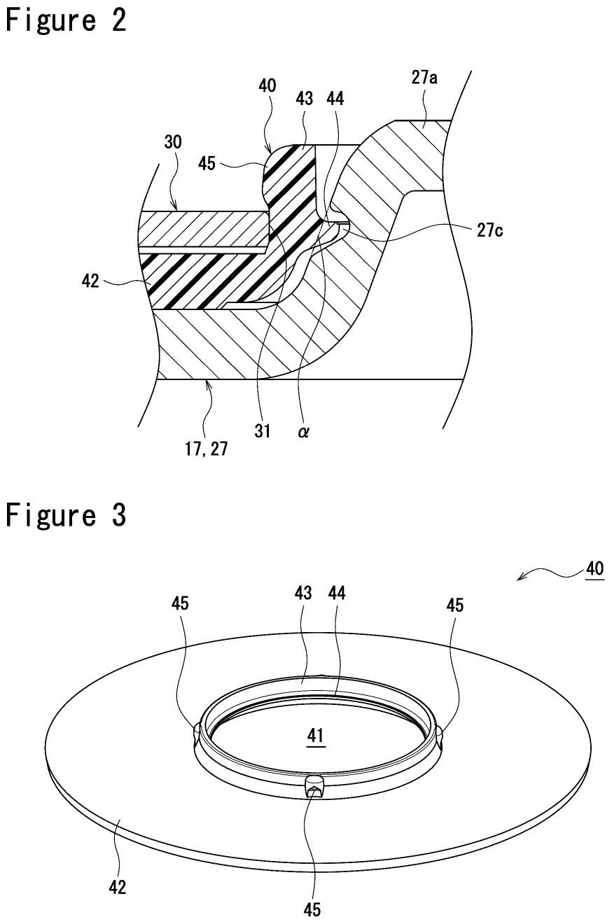

Hereinafter, with reference to FIGS. 2 and 3, the external terminal 30, the insulating member 40, and the cap 27 constituting the sealing assembly 17 are described in detail. FIG. 2 is an enlarged view of a portion A in FIG. 1, and FIG. 3 is a perspective view of the insulating member 40. In this specification, the lower surface of the sealing assembly 17, the external terminal 30, and the insulating member 40 means the surface facing the side of the electrode assembly 14, and the upper surface means the surface facing the outside of the battery that is opposite to the upper surface.

As shown in FIG. 2, the external terminal 30 is an annular (ring-shaped) member including an opening portion 31 and is located on the upper surface of the case 15. The external terminal 30 covers a large area of the upper surface of the case 15, except for the projecting portion 27a of the cap 27, and forms the upper surface of the cylindrical battery 10 together with the projecting portion 27a. The external terminal 30 is, for example, a substantially flat annular metal plate, though its shape, size, and the like are not particularly limited. In the present embodiment, the external terminal 30 is arranged on the upper surface of the case 15 without extending to a radially outer side than the outer circumferential surface of the outer can 16. Here, the external terminal 30 is arranged so that its radial direction is parallel to the radial direction of the cylindrical battery 10 (the same applies to the insulating member 40).

The opening portion 31 of the external terminal 30 has, for example, a perfect circle shape in planer view and is formed in a radially central portion of the external terminal 30. The opening portion 31 is a hole that allows insertion of the projecting portion 27a of the cap 27 and that is larger in diameter than the projecting portion 27a. The projecting portion 27a protrudes upward through the opening portion 31, and the top surface of the projecting portion 27a is located at the upper end of the cylindrical battery 10. Here, the insulating member 40 is also interposed between an inner circumferential portion of the external terminal 30 along the circumferential edge of the opening portion 31 and the side surface of the projecting portion 27a.

The external terminal 30 is constituted of, for example, iron or iron alloy, such as stainless steel, and is laser welded to the caulked portion 29 of the outer can 16. The external terminal 30 may include a thick-walled portion and a thin-walled portion and in this case, the thin-walled portion is welded to the caulked portion 29. A welded portion between the caulked portion 29 and the external terminal 30 may be formed in plurality in an intermittent manner at a prescribed interval in the circumference direction of the external terminal 30. The number and area of the welded portions may be set in consideration of joining strength and resistance, for example. In general, as the welded area is larger, the joining strength can be made higher and the resistance be made lower.

As shown in FIGS. 2 and 3, the insulating member 40, which is an annular member having an opening portion 41, is arranged between the cap 27 of the sealing assembly 17 and the external terminal 30. The insulating member 40 is smaller in diameter than the external terminal 30. The insulating member 40 may be constituted of, for example, the same resin as in the gasket 28, such as polyolefin, or may be constituted of resin having a higher heat resistance than the gasket 28, that is, fluororesin such as tetrafluoroethylene-perfluoroalkoxyethylene copolymer (PFA).

The opening portion 41 of the insulating member 40 has, for example, a perfect circle shape in planer view and is formed in a radially central portion of the insulating member 40. The opening portion 41 is a hole that allows insertion of the projecting portion 27a of the cap 27 and that is formed to be large enough to allow insertion of the projecting portion 27a. The insulating member 40 is preferably arranged to be more on the side of the center axis of the cylindrical battery 10 than the tip of the caulked portion 29 so as not to interfere with the welding of the caulked portion 29 of the outer can 16 and the external terminal 30.

The insulating member 40 includes a base portion 42 formed in an annular shape and a cylindrical portion 43 formed at the circumferential edge of the opening portion 41. The cylindrical portion 43 is inserted into the opening portion 31 of the external terminal 30 and protrudes above the top surface of the external terminal 30 as in the case of the projecting portion 27a of the cap 27. Inside the cylindrical portion 43, the projecting portion 27a that is inserted into the opening portion 41 is arranged. In the present embodiment, the upper end of the cylindrical portion 43 is located between the upper surface of the external terminal 30 and the top surface of the projecting portion 27a. In this case, the insulating member 40 does not get in the way when the projecting portion 27a is connected to the current collector. It also becomes easy to fix the insulating member 40 to the external terminal 30.

The base portion 42 is formed in a substantially flat plate shape, and is in contact with the upper surface of the cap 27 and the lower surface of the external terminal 30. Specifically, the base portion 42 is held between the cap 27 and the external terminal 30 from above and below, and thereby prevents contact between the cap 27 and the external terminal 30. The thickness of the base portion 42 is not particularly limited, though the thickness is larger than that of the external terminal 30 in the present embodiment. The insulating member 40 may be arranged between the caulked portion 29 and the gasket 28 that protrudes from between the sealing assembly 17, at an interval, or may be arranged so that the base portion 42 partially overlap the gasket 28.

The cylindrical portion 43 may extend upward from the base portion 42 and be formed substantially perpendicular to the upper surface of the base portion 42. The cylindrical portion 43 is formed like a wall surrounding the projecting portion 27a of the cap 27 and is arranged along the circumferential edge of the opening portion 31 of the external terminal 30. The cylindrical portion 43 is interposed between the inner circumferential portion of the external terminal 30 and the side surface of the projecting portion 27a to prevent contact between the external terminal 30 and the projecting portion 27a as described above. The insulating member 40 has a fixing structure to maintain the coupled state of the sealing assembly 17 and the external terminal 30, and in the present embodiment, the fixing structure is formed in the cylindrical portion 43.

The insulating member 40 includes a first protrusion 44 protruding toward the sealing assembly 17 and a second protrusion 45 protruding toward the external terminal 30 so as to reach an outer surface of the external terminal 30. Both the protrusions 44 and 45 are formed in the cylindrical portion 43 so as to protrude in directions opposite to each other along the radial direction of the insulating member 40 (cylindrical battery 10). The protrusions 44 and 45 may be arranged at the same height, though in the present embodiment, the protrusion 45 is arranged above the protrusion 44. The sealing assembly 17 also includes the groove 27c that allows insertion of the protrusion 44 of the insulating member 40.

The groove 27c of the sealing assembly 17, which is a recessed portion that allows insertion of the protrusion 44, is annularly formed on the side surface of the projecting portion 27a. The groove 27c is formed, for example, in a central portion in the up-down direction on the side surface of the projecting portion 27a, as a single groove continuous in the circumferential direction of the projecting portion 27a, with its width and depth large enough to allow insertion of the protrusion 44. From the perspective of achieving both retentivity of the protrusion 44 and the strength of the projecting portion 27a, the groove 27c preferably has a depth that is greater than or equal to 10% and less than or equal to 50% of a minimum thickness of the projecting portion 27a other than the area of the projecting portion 27a where the groove 27c is formed, and more preferably has a depth that is greater than or equal to 20% and less than or equal to 40% of the minimum thickness. Here, the depth of the groove 27c means the shortest distance from a virtual line α along the side surface of the projecting portion 27a to a deepest portion of the groove 27c in a cross sectional view of FIG. 2.

The first protrusion 44 of the insulating member 40 is annularly formed at the circumferential edge of the opening portion 41. In the present embodiment, the cylindrical portion 43 is formed at the circumferential edge of the opening portion 41, and the protrusion 44 is formed on the inner peripheral surface of the cylindrical portion 43. For example, the protrusion 44 is formed into the shape of a single rib that protrudes toward the inside of the cylindrical portion 43 at the central portion in the up-down direction of the cylindrical portion 43 and that continues in the circumferential direction of the cylindrical portion 43. A protruding length of the protrusion 44, which is not particularly limited, is greater than or equal to 0.20 mm and less than or equal to 0.30 mm in a suitable example. Note that the protruding length of the protrusion means the length from the base to the tip of the protrusion in the radial direction of the insulating member 40.

The protrusion 44 is preferably easy to insert into the groove 27c of the cap 27 and difficult to remove from the groove 27c. The insulating member 40 is attached to the cap 27 from above after the sealing assembly 17 is fixed to the opening edge portion of the outer can 16. Therefore, in the present embodiment, the lower surface of the protrusion 44 is inclined so as to be located gradually upward toward the tip from the base of the protrusion 44 so that the protrusion 44 is easily fitted in the groove 27c. The angle of inclination of the lower surface of the protrusion 44 relative to the radial direction of the insulating member 40 is, for example, greater than or equal to 15° and less than or equal to 45° in the central portion of the protrusion 44 in a length direction. The lower surface of the protrusion 44 may be curved so as to project downward.

The upper surface of the protrusion 44 may be formed along the radial direction of the insulating member 40 so as to be easily caught in the groove 27c. The angle of inclination of the upper surface of the protrusion 44 relative to the radial direction of the insulating member 40 is, for example, greater than or equal to 0° and less than or equal to 5° in the central portion of the protrusion 44 in the length direction. At least a part of the upper surface of the protrusion 44 may be formed substantially perpendicular (90°±5°) to the inner circumferential surface of the cylindrical portion 43 located above the protrusion 44.

The protrusion 44 is formed into a tapered shape that is made slightly narrower toward the tip from the base due to the inclination of the lower surface described above. The groove 27c of the cap 27 has a groove width gradually narrowed toward the bottom of the groove to match the tapered shape of the protrusion 44. The protrusion 44 also preferably has the same protruding length and width over the entire length. Similarly, the groove 27c also preferably has the same depth and width over the entire length. In this case, retaining force of the protrusion 44 by the groove 27c is uniform along the circumference direction of the projecting portion 27a.

The second protrusion 45 of the insulating member 40 is formed in plurality in an intermittent manner along the circumferential edge of the opening portion 31 of the external terminal 30. In the present embodiment, the cylindrical portion 43 is formed along the circumferential edge of the opening portion 31, and the protrusions 45 are formed on the outer circumferential surface of the cylindrical portion 43. The number of the protrusions 45 is not particularly limited, though the number is preferably greater than or equal to three, more preferably greater than or equal to four, and in a suitable example, the number is greater than or equal to four and less than or equal to ten. In the present embodiment, the four protrusions 45 are arranged at equal intervals in the circumferential direction of the cylindrical portion 43. The protrusions 45 are all formed in the same shape and with the same size.

The protrusion 45 is caught on the upper surface of the external terminal 30 and holds the external terminal 30 with the base portion 42 from above and below. As a result, the insulating member 40 is retained by the external terminal 30. The protrusion 45 is required to be caught on the upper surface of the external terminal 30 and not to be removed from the upper surface of the external terminal 30 even when the weight of the insulating member 40 and the sealing assembly 17 is added. On the other hand, since the external terminal 30 is fitted between the protrusions 45 and the base portion 42 beyond the protrusions 45, the protrusions 45 are also required not to interfere with the attachment of the external terminal 30. A suitable protruding length of protrusions 45 is, for example, greater than or equal to 0.10 mm and less than or equal to 0.20 mm. In the present embodiment, the protruding length of the protrusions 45 is shorter than the protruding length of the protrusion 44.

The protrusions 45 may be formed in the range from the upper end of the cylindrical portion 43 to the central portion of the cylindrical portion 43 in the up-down direction, and an up-down direction length of the protrusions 45 may appropriately be changed in accordance with the thickness of the external terminal 30. The upper surface of the protrusions 45 is curved so as to project upward, for example. In this case, it becomes easy to attach the external terminal 30. On the other hand, the lower surface of the protrusions 45 may be formed with a hollow, a step, or the like, into which the external terminal 30 fits so that the upper surface of the external terminal 30 is easily caught, and may be formed along the radial direction of the insulating member 40.

Here, the first protrusion 44 may be formed in plurality in an intermittent manner at the circumferential edge of the opening portion 41. In this case, the recessed portion of the cap 27 may be the groove 27c annularly formed on the side surface of the groove 27c, or may be formed in plurality (the same number as the protrusions 44) in an intermittent manner in match with the positions of the protrusions 44. In the case of the second protrusion 45, the protrusion 45 may be formed annularly along the circumferential edge of the opening portion 31 of the external terminal 30. Both the protrusions 44 and 45 may be formed into the shape of a single rib or be formed in plurality in an intermittent manner.

As described in the foregoing, according to the cylindrical battery 10 having the above configuration, the sealing assembly 17 is fixed to the external terminal 30 via the insulating member 40, which can prevent dropping of the sealing assembly 17 even when the gasket 28 melts due to abnormal heat generation in the battery. This can suppress the occurrence of a short circuit due to the contact between the outer can 16 and the sealing assembly 17.

In the present embodiment, the case where the sealing assembly 17 functions as a positive electrode external terminal, and the external terminal 30 functions as a negative electrode external terminal has been illustrated, though it is also possible to adopt a mode in which the external terminal 30 is the positive electrode external terminal and the sealing assembly 17 is the negative electrode external terminal. In other words, it is possible to set the first electrode to be the negative electrode 12 and the second electrode to be the positive electrode 11.

In the present embodiment, the sealing assembly 17 includes a gas exhaust mechanism, so that gas is exhausted from the sealing assembly 17 on the occurrence of abnormality in the battery, though a sealing assembly not including the gas exhaust mechanism may also be used. In this case, a gas exhaust structure is formed at the bottom of the outer can, for example.

In the present embodiment, the protrusion 44 that is formed in the insulating member 40 and the groove 27c that is formed in the projecting portion 27a of the sealing assembly 17 have been illustrated as the fixing structure of the sealing assembly and the insulating member, though it is also possible to form the protrusion in the sealing assembly and form the recessed portion that allows insertion of the protrusion in the insulating member.

### REFERENCE SIGNS LIST

10 Cylindrical battery, 11 Positive electrode, 12 Negative electrode, 13 Separator, 14 Electrode assembly, 16 Outer can, 17 Sealing assembly, 18, 19 Insulating plate, 20 Positive electrode lead, 21 Negative electrode lead, 22 Grooved portion, 23 Internal terminal plate, 24 Lower vent member, 25 Insulating plate, 26 Upper vent member, 27 Cap, 27a Projecting portion, 27b Vent hole, 27c Groove, 28 Gasket, 29 Caulked portion, 30 External terminal, 31,41 Opening portion, 40 Insulating member, 42 Base portion, 43 Cylindrical portion, 44 First protrusion, 45 Second protrusion

1. A cylindrical battery, comprising:
an electrode assembly including a first electrode and a second electrode;
a bottomed cylindrical outer can that houses the electrode assembly; and
a sealing assembly that seals an opening portion of the outer can,
the first electrode being connected to the outer can, the second electrode being connected to the sealing assembly,
the cylindrical battery further comprising:
a gasket interposed between the outer can and the sealing assembly;
an external terminal joined to an outer surface of the outer can; and
an insulating member interposed between the sealing assembly and the external terminal, wherein
the sealing assembly is fixed to the external terminal via the insulating member.

2. The cylindrical battery according to claim 1, wherein
the insulating member includes a first protrusion protruding toward the sealing assembly and a second protrusion protruding toward the external terminal so as to reach an outer surface of the external terminal, and
the sealing assembly includes a recessed portion that allows insertion of the first protrusion.

3. The cylindrical battery according to claim 2, wherein
the sealing assembly includes a top plate including a projecting portion that expands outward,
the recessed portion is annularly formed or formed in plurality in an intermittent manner on a side surface of the projecting portion,
the insulating member includes an opening portion that allows the projecting portion to pass through, and
the first protrusion is annularly formed at a circumferential edge of the opening portion.

4. The cylindrical battery according to claim 2, wherein
the sealing assembly includes a top plate including a projecting portion that expands outward,
the recessed portion is annularly formed or formed in plurality in an intermittent manner on a side surface of the projecting portion,
the insulating member includes an opening portion that allows the projecting portion to pass through, and
the first protrusion is formed in plurality in an intermittent manner at a circumferential edge of the opening portion.

5. The cylindrical battery according to claim 2, wherein
the external terminal includes a terminal opening portion that allows the insulating member to pass through, and
the second protrusion of the insulating member is annularly formed along a circumferential edge of the terminal opening portion.

6. The cylindrical battery according to claim 2, wherein
the external terminal includes a terminal opening portion that allows the insulating member to pass through, and
the second protrusion of the insulating member is formed in plurality in an intermittent manner along a circumferential edge of the terminal opening portion.
